(19) United States
(12) Patent Application Publication
(10) Pub. No.: US 2025/0247548 A1
(43) Pub. Date: Jul. 31, 2025

(54) SAMPLE-WISE EXTRAPOLATED INTRA PREDICTION

(71) Applicant: Tencent America LLC, Palo Alto, CA (US)

(72) Inventors: Yonguk YOON, Palo Alto, CA (US); Lien-Fei Chen, Palo Alto, CA (US); Biao Wang, Palo Alto, CA (US); Roman Chernyak, Palo Alto, CA (US); Motong Xu, Palo Alto, CA (US); Shan Liu, Palo Alto, CA (US)

(21) Appl. No.: 19/039,633

(22) Filed: Jan. 28, 2025

Related U.S. Application Data
(60) Provisional application No. 63/627,678, filed on Jan. 31, 2024.

(51) Int. Cl. H04N 19/159; H04N 19/117; H04N 19/176; H04N 19/196

(52) U.S. Cl. CPC H04N 19/159; H04N 19/117; H04N 19/176; H04N 19/196

(57) ABSTRACT

The various implementations described herein include methods and systems for coding video. In one aspect, a method includes receiving a video bitstream comprising a plurality of blocks that includes a current block; selecting a selected extrapolation filter from a set of extrapolation filters; deriving a prediction sample for the current block using an extrapolated intra prediction with the selected extrapolation filter; and reconstructing the current block using the derived prediction sample.

### RELATED APPLICATIONS

This application claims priority to U.S. Provisional Patent Application No. 63/627,678, entitled “Sample-Wise Extrapolated Intra Prediction” filed Jan. 31, 2024, which is hereby incorporated by reference in its entirety.

### TECHNICAL FIELD

The disclosed embodiments relate generally to video coding, including but not limited to systems and methods for extrapolated intra prediction.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released. Enhanced Compression Model (ECM) is a video coding standard that is currently under development. ECM aims to significantly improve compression efficiency beyond existing standards like HEVC/H.265 and VVC, essentially allowing for higher quality video at lower bitrates. ECM version 13 was published on Jul. 7, 2024 in MPEG 146.

### SUMMARY

The present disclosure describes amongst other things, a set of methods for video (image) compression, more specifically related to selection and/or customization of an n-tap extrapolation filter for intra prediction. Some embodiments include using a sample-wise extrapolated intra prediction. For example, an n-tap extrapolation filter may be selected from a set of n-tap extrapolation filters and/or coefficients of the n-tap extrapolation filter may be adaptively generated using different models and/or classifiers to provide higher coding accuracy. Some embodiments include using extrapolation filters having different shapes and/or being used in different prediction order to generate a prediction sample. Using different shapes and/or prediction orders can further improve coding accuracy, e.g., by applying the most appropriate filter at the most appropriate time. Some embodiments include using reconstructed samples to predict remaining samples. Using partially reconstructed blocks to predict the remaining samples can improve coding accuracy, e.g., by providing more accuracy predictions.

In accordance with some embodiments, a method of video decoding is provided. The method includes (i) receiving a video bitstream (e.g., a coded video sequence) comprising a plurality of blocks that includes a current block; (ii) selecting a selected extrapolation filter from a set of extrapolation filters; (iii) deriving a prediction sample for the current block using an extrapolated intra prediction with the selected extrapolation filter; and (iv) reconstructing the current block using the derived prediction sample.

In accordance with some embodiments, a method of video encoding includes (i) (i) receiving video data (e.g., a source video sequence) comprising a current picture that includes a plurality of blocks, the plurality of blocks including a current block. The method includes (ii) selecting a selected extrapolation filter from a set of extrapolation filters; (iii) encoding the current block by applying the selected extrapolation filter; and (iv) signaling the encoded current block in a video bitstream.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates an example of an extrapolated intra prediction technique in accordance with some embodiments.

FIG. 4B illustrates an example of an extrapolated intra prediction technique in accordance with some embodiments.

FIG. 4C illustrates an example of an extrapolated intra prediction technique in accordance with some embodiments.

FIG. 4D illustrates examples of an extrapolated intra prediction technique using different movement directions of the extrapolation filter in accordance with some embodiments.

FIG. 4E illustrates an example of an extrapolated intra prediction technique using reconstructed samples in accordance with some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes video/image compression techniques including using sample-wise extrapolated intra predictions. For example, an extrapolation filter may be selected from a set of extrapolation filters. In this example, a prediction sample for the current block may be derived using an extrapolated intra prediction with the selected extrapolation filter, and the current block may be reconstructed using the derived prediction sample. Applying an extrapolation filter in this manner can improve coding accuracy, e.g., by filtering noise from the predictions. In another example, a parameter (e.g., for a filter shape and/or prediction order) is selected for an extrapolation filter, and a prediction sample is derived for the current block using the extrapolation filter with the selected parameter. Adjusting the filter parameters in this manner can improve coding accuracy, e.g., by applying the best suited filter. In another example, a partial prediction block is generated for the current block using an extrapolation filter. A portion of the current block corresponding to the partial prediction block is reconstructed by applying a transformation. A prediction sample for a second portion of the current block is derived based on the reconstructed portion of the current block. Deriving prediction samples using reconstructed samples in this manner can improve coding accuracy, e.g., by providing more accurate predictions.

### Example Systems and Devices

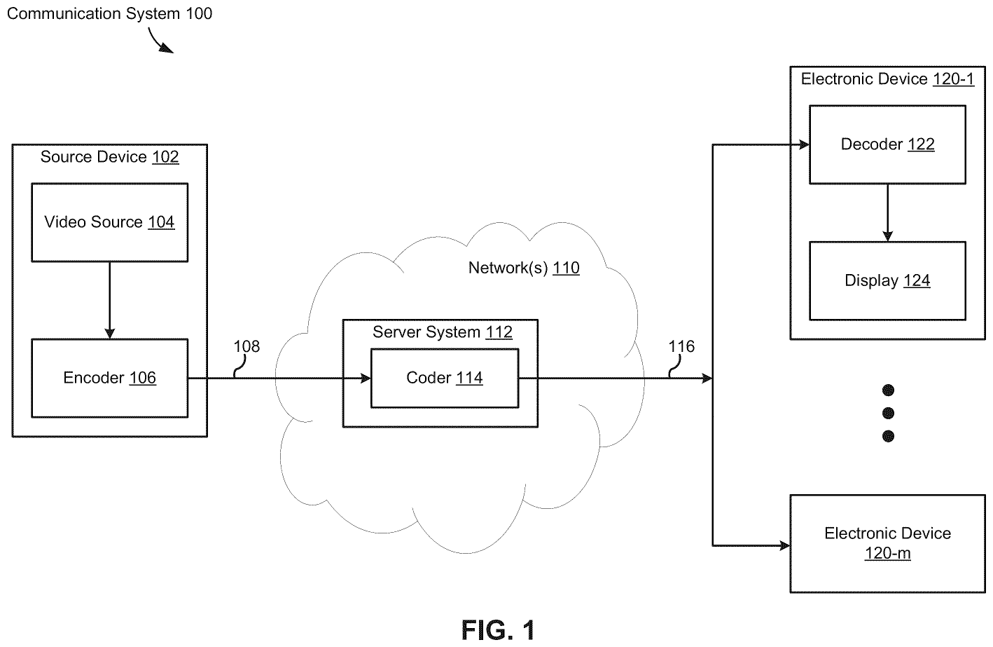

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

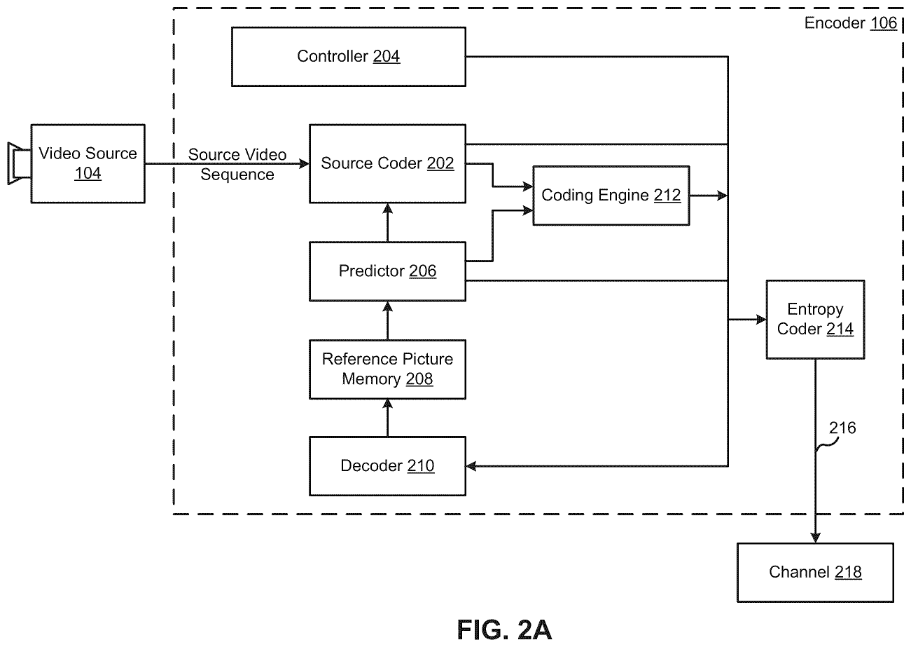

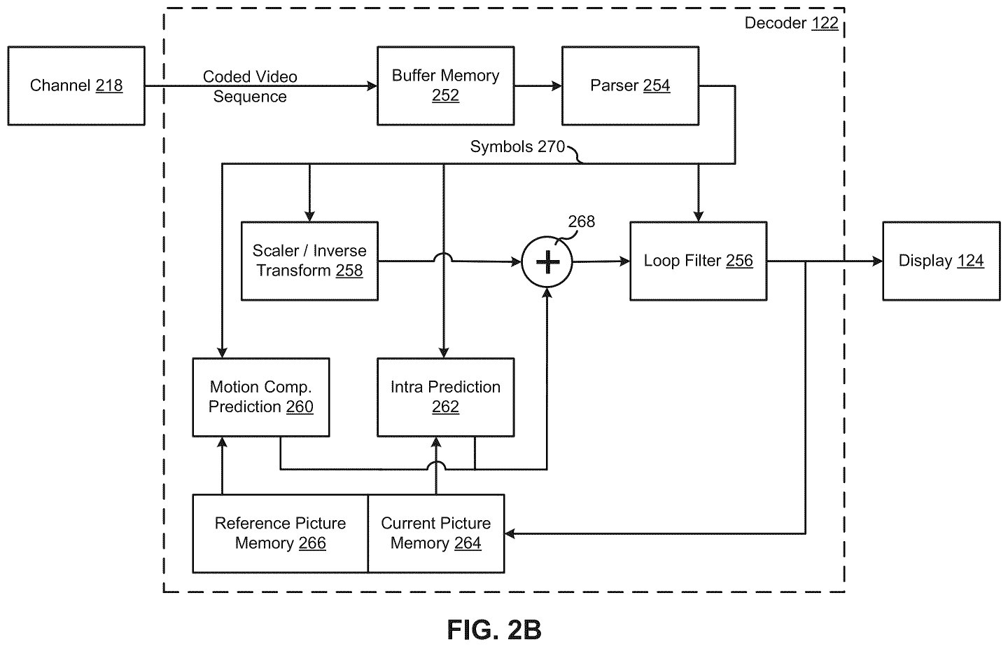

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

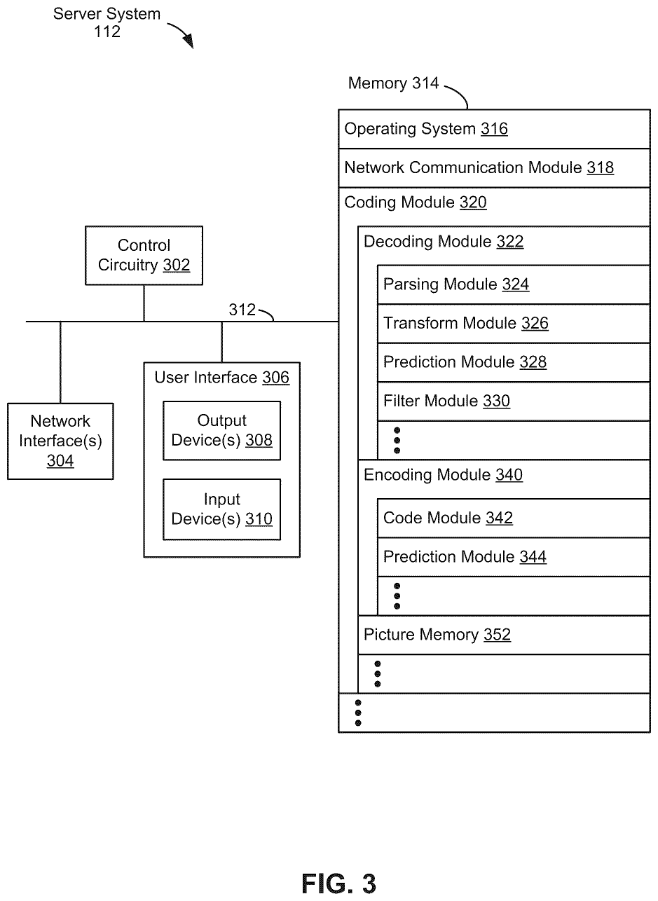

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, example methods selection and customization of extrapolation filters for intra prediction are described below.

In the following description, a “reference sample” may refer to a reconstructed neighboring sample of a current block or a sequentially predicted sample. A “n-tap extrapolation filter” may refer to a filter having n coefficients. “A set of extrapolation filters” may refer to a set of several n-tap extrapolation filters. “A group of extrapolation filter sets” may refer to a of several extrapolation filter sets. Block size, or region size, may refer to the block/region width, height, area size, number of samples in the block/region, max (or min) between block/region width and height, and/or block/region aspect ratio.

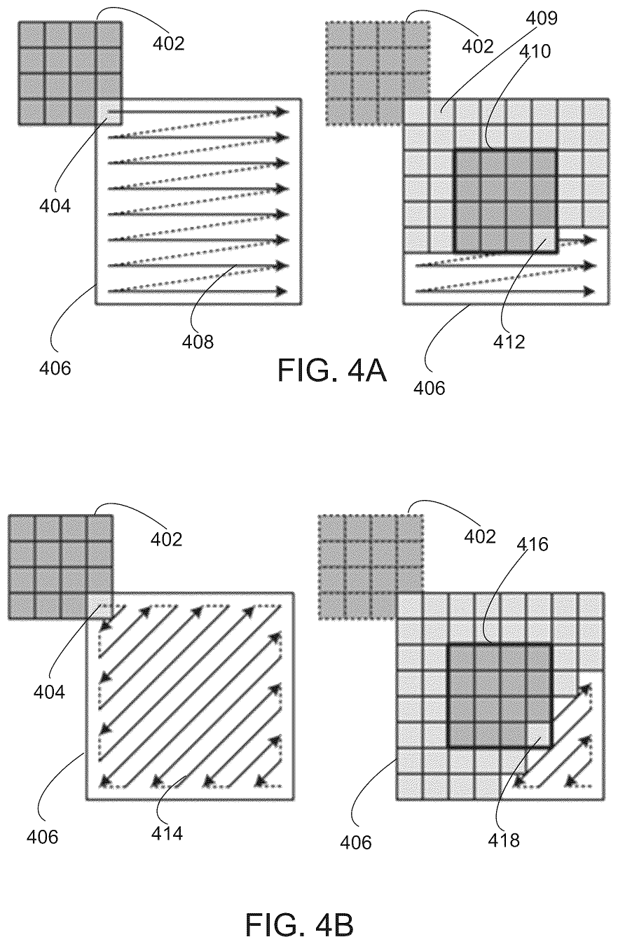

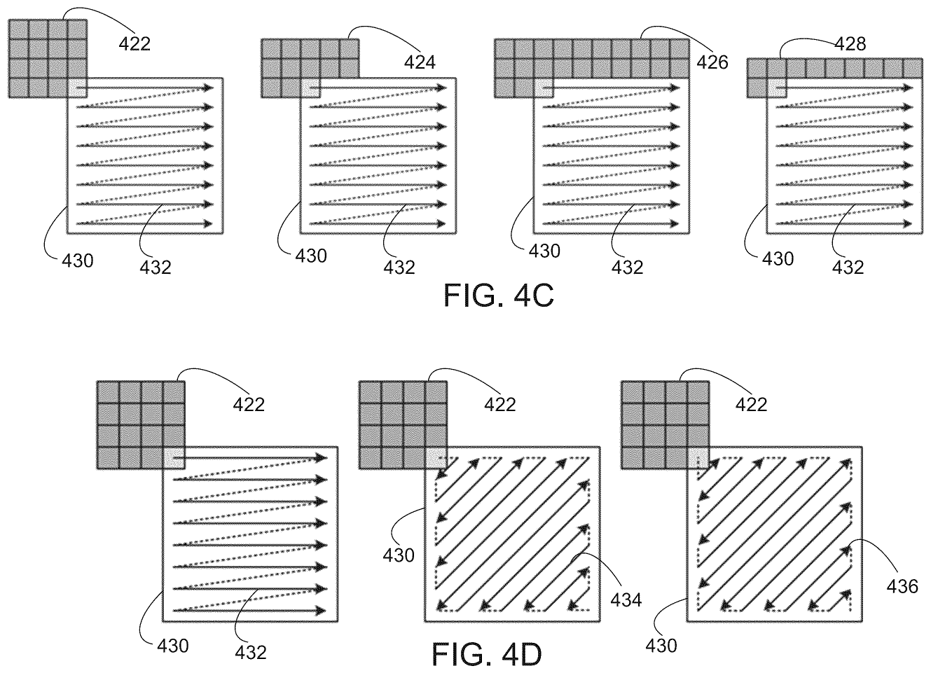

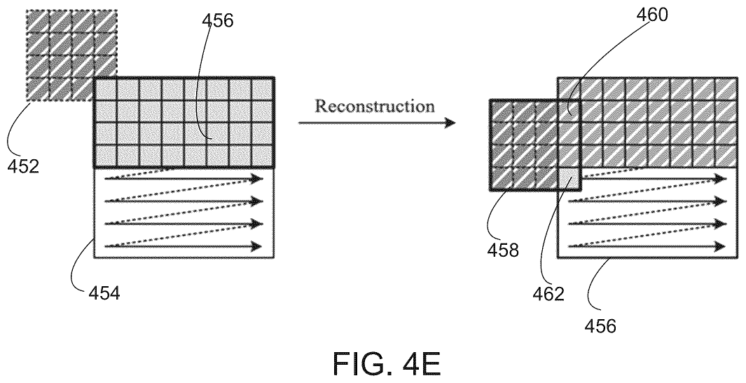

FIG. 4A illustrates an example of an extrapolated intra prediction technique, in accordance with some embodiments. In the example of FIG. 4A, the extrapolated intra prediction technique includes using a n-tap extrapolation filter (e.g., illustrated as a 15-tap extrapolation filter 402 in FIG. 4A) to predict a sample 404 in a current block 406. For example, the prediction of the sample 404 includes a summation of a product of each of the coefficients of the 15-tap extrapolation filter and a corresponding reconstructed sample or predicted sample at a respective position (e.g., having the associated coefficient) of the 15-tap extrapolation filter. After the sample 404 has been predicted, the 15-tap extrapolation filter 402 is moved leftward by one sample, along a direction 408 to predict a sample 409, to the right of the sample 404. The sample 404 is used by n-tap extrapolation filter 402 to predict the sample 409. When the 15-tap extrapolation filter 402 moves to the end of the first row of samples in the current block 406, the 15-tap extrapolation filter 402 moves down to predict the leftmost sample in a second row (e.g., one row down from the first row). The right portion of FIG. 4A shows that the 15-tap extrapolation filter 402 has sequentially moved from its previous position indicated by a dotted outline. A 15-tap extrapolation filter 410 in a central portion of the coding block 406 is used to predict a sample 412. In some embodiments, an n-tap extrapolation filter (e.g., the 15-tap extrapolation filter 402) has fixed coefficients for each of the n positions in the filter (e.g., 15 positions in the filter 402). In such scenarios, the 15-tap extrapolation filter 402 is identical to (e.g., has the same 15 coefficients) the 15-tap extrapolation filter 410. For example, reconstructed samples may be used as training data for a machine learning model, and the machine learning model is trained offline using the reconstructed samples to generate coefficients for the n-tap extrapolation filter that minimize a loss function between the predicted sample generated using the n-tap extrapolation filter and an actual sample value. In some embodiments, the trained model is used in the encoding stage to provide the fixed coefficients for the n-tap extrapolation filter.

In some embodiments, the coefficients of the 15-tap extrapolation filter 402 are adaptive coefficients. For example, the 15-tap extrapolation filter 402 has coefficients that are distinct from the coefficients in the 15-tap extrapolation filter 410. In some embodiments, the adaptive filter coefficients are trained on the fly (e.g., during the encoding stage, using neighboring samples that are reconstructed samples or predicted samples (also sometimes referred to hereinafter as reference sample). For example, a model for generating the adaptive filter coefficients may be trained during the encoding stage, and the training models may be a regression model, a linear model, or another model. In some embodiments, the adaptive filter coefficients are weights that are applied to each reference sample, and the weights are calculated on the fly during the decoding stage. In some embodiments, the same reference samples (e.g., the same reconstructed samples) are used at both the encoder and the decoder.

In some embodiments, a filter set includes at least one n-tap extrapolation filter having fixed coefficients and at least one n-tap extrapolation filter having adaptive coefficients.

In some embodiments, a classifier is used at both the encoder and at the decoder and the selection of a particular filter from a filter set and/or filter coefficients is not signaled. The classifier may be defined to classify the neighboring samples into different number of groups where each group is associated with a respective n-tap extrapolation filter. Using, as an example, a classifier that selects between two filters, reference samples are separated into two groups, and samples from each group is used as a training set to derive a respective extrapolation filter. The classification process may be based on one or more characteristics of the reference samples (e.g., average value of all reference samples, weighted averages, median values) being lower or equal to a threshold value (e.g., classified into a first group, associated with a first n-tap extrapolation filter) or being higher than the threshold value (e.g., classified into a second group, associated with a second n-tap extrapolation filter different from the first n-tap extrapolation filter). For example, the threshold value maybe the average value for the characteristic across all reference samples of a specific neighboring region in a training data set.

In some embodiments, a selection metric such as a rate-distortion based cost is calculated at the encoder to select a particular filter and/or filter coefficients, and the selected filter is signaled. In some embodiments, a filter set is selected from a filter group using a classifier and a filter from the filter set (e.g., selected by the classifier) is selected based on a selection metric, such as a rate-distortion based cost, and the selected filter is signaled with syntax elements.

In some embodiments, an intra prediction mode derived using Template-based Intra Mode Derivation (TIMD) is used as a classification index and used to select a filter and/or a filter set. For example, an intra prediction mode is derived using TIMD for some reference samples. In some embodiments, the highest listed mode for some reference samples in Decoder-Side Intra Mode Derivation (DIMD) is used to select a filter and/or a filter set. In some embodiments, the intra prediction modes derived either by TIMD or DIMD may be mapped, via a look-up table, to a specific filter. For example, the look-up table may store a mapping correspondence between an intra prediction mode and a filter (e.g., intra-prediction at 45 degree maps to a first n-tap extrapolation filter).

In some embodiments, gradient-based classifiers, such as adaptive loop filters, are used to derive a classification index for reference samples. In some embodiments, directionality of the reference samples, based on the gradients of horizontal and vertical are used to determine the classification index. In some embodiments, activity is calculated by a summation of the gradients. In some embodiments, directionality and/or activity is used to classify reference samples. In some embodiments, another look-up table is used to map gradient (e.g., derived from pixel level information of the current block) to specific filters.

In some embodiments, a matrix-based classifier (e.g., a neural network based classifier) is used to derive a classification index. In some embodiments, the matrix is trained offline using reference samples to select a filter that minimize loss or another performance metric.

FIG. 4B illustrates an example of an extrapolated intra prediction technique, in accordance with some embodiments. In this example, the extrapolated intra prediction technique includes using a n-tap extrapolation filter (e.g., the 15-tap extrapolation filter 402 in FIG. 4B, analogous to the 15-tap extrapolation filter 402 in FIG. 4A) to predict the sample 404 in the current block 406, analogous to the description provided with reference to FIG. 4A. The example illustrated in FIG. 4B differs from the example illustrated in FIG. 4A due to a zig-zag direction 414 that moves the 15-tap extrapolation filter 402 (i) leftward, (ii) downward toward the left, (iii) downward, (iv) upward toward the right, etc., as illustrated in FIG. 4B (e.g., as opposed to the left-to-right movement along the direction 408 illustrated in FIG. 4A). As a result of the different movement directions of the 15-tap extrapolation filter 402, the current block 406 is populated with predicted samples in a different order. Similarly, depending on whether the 15-tap extrapolation filter 402 is a filter having fixed coefficients or whether the 15-tap extrapolation filter 402 is a filter having adaptive coefficients, in some embodiments, a 15-tap extrapolation filter 416 (e.g., used to predict a sample 418) is different from the 15-tap extrapolation filter 410 (and the 15-tap extrapolation filter 402) due to the order in which samples are predicted.

FIG. 4C illustrates examples of an extrapolated intra prediction technique using different n-tap extrapolation filters, in accordance with some embodiments. In the illustrated examples of FIG. 4C, the same current block 430 is predicted in the same direction 432 but using a square 15-tap extrapolation filter 422, an L-shape 12-tap extrapolation filter 424, an L-shape 22-tap extrapolation filter, and an L-shape 10-tap extrapolation filter 428.

In some embodiments, a fixed filter shape is used to predict the whole block, regardless of current block shape, size, or other coding information. In some embodiments, the filter shape and/or size is selected based on block shape, size, and/or other coding information. In some embodiments, based on the number of filter shapes available on the encoder side, the shape giving rise to the best performance (e.g., based on the lowest rate-distortion costs) is selected, and an index associated with the selected shape is signaled into the bitstream. In some embodiments, the filter shape is determined using a classifier (e.g., at both the encoder and at the decoder). For example, the shape of the filter is selected by the classifier based on an intra prediction mode of reference samples (e.g., determined using TIMD or DIMD) and/or a block shape of the current block. In some embodiments, the shape of the filter is selected based on a rate-distortion cost and a syntax element indicating the selected filter is signaled into the bitstream.

FIG. 4D illustrates examples of an extrapolated intra prediction technique using different movement directions of the extrapolation filter, in accordance with some embodiments. In the illustrated examples of FIG. 4D, the same 15-tap extrapolation filter 422 in the same left-to-right direction 432 (analogous to the leftmost example illustrated in FIG. 4C), moves right first before moving downward in a zig-zag direction 434, or moves down first below moving upwards in a zig-zag direction 436 to predict samples in the current block 430.

FIG. 4E illustrates an example of an extrapolated intra prediction technique using reconstructed samples, in accordance with some embodiments. As an example, dashed squares in FIG. 4E represent reconstructed samples, while light gray squares represent predicted samples. A current block 454 in FIG. 4E includes a number of predicted samples, illustrated as gray squares. In some embodiments, after N samples are generated by the n-tap extrapolation filter 452, a generated partial prediction block 456 is reconstructed using an existing transform kernel and quantization to generate a partial reconstructed block 460. For example, the current block 454 may be an 8×8 block, and after 8×4 samples are predicted (e.g., sequentially, using the n-tap extrapolation filter 452) the n-tap extrapolation 452 is then used to reconstruct the 8×4 predicted samples. As shown on the right portion of FIG. 4E, after the 8×4 predicted samples have been reconstructed, using the n-tap extrapolation 452 (and denoted as 8×4 dashed squares), a next predicted sample 462 is generated based on an n-tap extrapolation filter 458 (e.g., optionally identical to n-tap extrapolation filter 452 when fixed filter coefficients are used) and reference samples that are reconstructed samples. In some embodiments, the use of the reconstructed samples to predict the sample 462 may result in a more accurate sample 462.

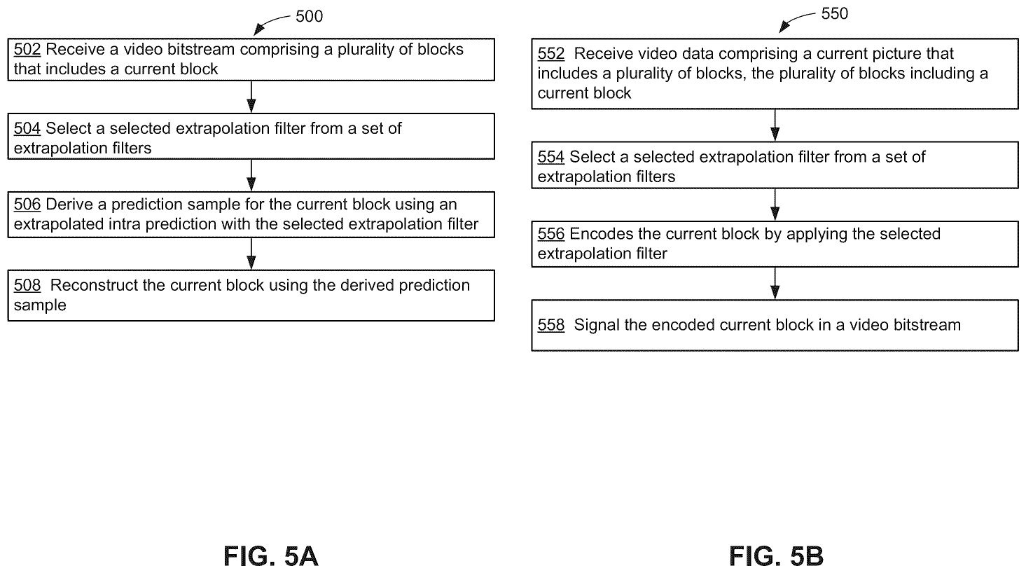

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream (e.g., a coded video sequence) comprising a plurality of blocks (e.g., corresponding to a set of pictures) that includes a current block. The system selects (504) a selected extrapolation filter from a set of extrapolation filters and derives (506) a prediction sample for the current block using an extrapolated intra prediction with the selected extrapolation filter. The system reconstructs (508) the current block using the derived prediction sample. In this way, a sample-wise extrapolated intra prediction is performed. For example, a general extrapolation intra prediction method includes a prediction sample is constructed from neighboring samples, using an n-tap extrapolation filter. Prediction samples may be generated sequentially as shown in FIG. 4A.

In some embodiments, extrapolation filter coefficients are either fixed coefficients or adaptive coefficients. A filter is selected among one or more filter sets and/or filter groups. To indicate which filter or filter set is used, a classifier classifies reference samples and/or a reference template into a classification index. In some embodiments, the filter coefficients are trained offline, and the filter is considered a fixed filter. In some embodiments, the filter coefficients are trained on the fly using neighboring samples, and the filter is considered an adaptive filter.

In some embodiments, a filter set consists of one or more fixed filters and/or adaptive filters. In some embodiments, the filter from the set can be selected according to rate-distortion based costs, and the selected filter is signaled with syntax elements. In some embodiments, the filter from the set can be selected using a classifier. In some embodiments, the filter set is selected from the filter group using a classifier and the filter from the set can be selected according to rate-distortion based costs. The selected filter is signaled with syntax elements.

In some embodiments, template-based intra prediction mode derivation methods can be utilized as a classifier to classify reference samples into a specific mode, which may be considered as the classification index.

In some embodiments, a gradients-based classifier derives classification index using reference samples. In one example, a gradients-based classifier derives directionality of reference samples by gradients of horizontal and vertical. Activity is calculated by a summation of the gradients. Directionality and activity are used to classify reference samples.

In some embodiments, a matrix-based classifier where a matrix is trained offline using reference samples derives a classification index.

In some embodiments, a prediction sample is generated by one or more different shape extrapolation filters and/or a different prediction order. FIG. 4B-4D show examples of various filter shapes and different prediction orders.

In some embodiments, a fixed filter shape can be used to predict whole block samples regardless of the current block shape, block size, and other coding information. In some embodiments, a filter shape is determined according to block shape, block size, and other coding information. In some embodiments, a filter shape is determined according to rate-distortion based costs and the selected filter shape is signaled with a syntax element. In some embodiments, a filter shape is determined using a classifier. In some embodiments, when the predicted samples can be reconstructed, reconstructed samples are used to predict remaining samples.

In some embodiments, when constructing an 8×8 block where 8×4 samples are sequentially generated using the filter, a generated partial prediction block is reconstructed using existing transform kernel and quantization. Next samples are predicted with reference samples and partially reconstructed samples as shown in FIG. 4E.

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 500 described above.

The system receives (552) video data (e.g., a source video sequence) comprising a current picture that includes a plurality of blocks (e.g., corresponding to a set of pictures), the plurality of blocks including a current block. The system selects (554) a selected extrapolation filter from a set of extrapolation filters and encodes (556) the current block by applying the selected extrapolation filter. The system signals (558) the encoded current block in a video bitstream. As described previously, the encoding process may mirror the decoding processes described herein (e.g., the selection of filter coefficients for n-tap extrapolation filters described above). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

Either a 15-tap or a 9-tap may be chosen based on a signaled index. Simulation data on ECM-14 software with common test conditions has shown that using a classifier to select between two different extrapolation filters improves coding of the luma (Y) component by 0.03%, improves the coding of the chroma (U) component by 0.02%, and improves the coding of the chroma (V) component by 0.03%.

An extrapolation filter may be chosen based on a classifier that classifiers samples into two groups. Training samples are classified into the two groups and used to derive two different extrapolation filters. Based on whether a reference value of the training sample is above a threshold (e.g., an average value of samples) or below or equal the threshold, the training sample is classified into a first group (above the threshold) or a second group (below or equal to the threshold). The same classification rule is applied during prediction of a current block. Simulation data on ECM-14 software with common test conditions has shown that using a classifier to select between two different extrapolation filters improves coding of the luma (Y) component by 0.07%, improves the coding of the chroma (U) component by 0.01%, and improves the coding of the chroma (V) component by 0.03%.

Although EMC is mentioned in the previous paragraphs, one of skill in the art would recognize that the methods described herein can be used in many existing codecs, such as those mentioned in the background section.

(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks that includes a current block; (ii) selecting a selected extrapolation filter from a set of extrapolation filters; (iii) deriving a prediction sample for the current block using an extrapolated intra prediction with the selected extrapolation filter; and (iv) reconstructing the current block using the derived prediction sample. For example, a sample-wise extrapolated intra prediction is used to reconstruct the current block. In an example extrapolation intra prediction method, a prediction sample is constructed from neighboring samples using n-tap extrapolation filter. In some embodiments, the extrapolation filter uses either fixed coefficients or adaptive coefficients. In some embodiments, the extrapolation filter is selected from among at least one or more filter sets and filter groups. To indicate which filter or filter set is used, a classifier classifies reference samples and/or reference template into classification index. In some embodiments, the extrapolation filter is selected from a set of extrapolation filters in accordance with a determination that the current block is encoded with an efficient intra prediction (EIP) mode.

(A2) In some embodiments of A1, the selected extrapolation filter is selected from the set of extrapolation filters according to an output of a classifier classifying one or more reference samples. For example, to indicate which filter or filter set is used, a classifier classifies reference samples and/or reference template into classification index. For example, the selected extrapolation filter is not signaled in the video bitstream, but is instead derived at a decoder component based on classification of one or more reference samples and/or reference templates. As an example, the filter from the set can be selected using a classifier.

(A3) In some embodiments of A2, the classifier uses a template-based intra prediction mode derivation to classify the one or more reference samples. For example, template-based intra prediction mode derivation methods may be utilized as a classifier to classify reference samples into a specific mode (e.g., considered as a classification index).

(A4) In some embodiments of A2, the classifier is a gradients-based classifier configured to derive at least one of directionality of the one or more reference samples and activity of the one or more reference samples. For example, a gradients-based classifier derives a classification index using the reference samples. For example, a gradients-based classifier derives directionality of reference samples by gradients of horizontal and vertical. The activity may be calculated by summation of gradients and directionality and activity may be used to classify reference samples.

(A5) In some embodiments of A2, the classifier is a matrix-based classifier. For example, matrix-based classifier where the matrix is trained offline using reference samples derives classification index.

(A6) In some embodiments of any of A2-A5, the one or more reference samples comprise reconstructed samples. For example, when the predicted samples can be reconstructed, reconstructed samples may be used to predict remaining samples. As an example, when constructing an 8×8 block, a partial prediction block (e.g., 8×4 samples) is generated using an extrapolation filter, and the generated partial prediction block may be reconstructed using existing transform kernel and quantization. In some embodiments, partial prediction blocks are sequentially generated using extrapolation filters.

(A7) In some embodiments of any of A1-A6, a set of filter coefficients for the selected extrapolation filter are trained in an offline manner. For example, the filter coefficients are trained offline, considering as fixed filter.

(A8) In some embodiments of any of A1-A7, a set of filter coefficients for the selected extrapolation filter are trained using a set of neighboring samples of the current block. For example, the filter coefficients are trained on the fly using neighboring samples, considering as adaptive filter.

(A9) In some embodiments of any of A1-A8, the set of extrapolation filters includes at least one fixed filter and at least one adaptive filter. For example, a filter set consists of either or both at least one or more fixed filter and adaptive filter. As described above, a fixed filter is trained in an offline manner whereas an adaptive filter is trained in an online manner.

(A10) In some embodiments of any of A1-A9, the method further includes parsing an indicator from the video bitstream, where the indicator indicates which filter to use from the set of extrapolation filters and wherein the selected extrapolation filter is selected according to the indicator. For example, the filter from the set can be selected according to rate-distortion based cost. As an example, the selected filter may be signaled with one or more syntax elements.

(A11) In some embodiments of any of A1-A10, the method further includes identifying a second reference block by applying the template-matching technique to the current block; identifying a second reference vector for the second reference block; and populating the merge candidate list with the second reference vector. For example, more than one motion vectors can be derived by using template-matching cost in ascending order. As an example, motion vectors from N blocks which have N smallest template-matching cost are identified during the template-matching process.

(A12) In some embodiments of any of A1-A11, the method further includes selecting the set of extrapolation filters from a group of extrapolation filter sets.

(A13) In some embodiments of A12, the method further includes parsing an indicator from the video bitstream, where the indicator indicates which filter set to use from the group of extrapolation filter sets and where the set of extrapolation filters is selected from the group of extrapolation filter sets according to the indicator. In some embodiments, the set of extrapolation filters are selected from the group of extrapolation filter sets according to an output of a classifier classifying one or more reference samples. For example, the filter set is selected from the filter group using a classifier and the filter from the set can be selected according to rate-distortion based cost, where the selected filter is signaled with syntax element(s).

(A14) In some embodiments of any of A1-A13, the prediction sample is derived using one or more different extrapolation filter shapes. For example, a prediction sample is generated by at least one or more different shaped extrapolation filters and/or different prediction orders.

(A15) In some embodiments of any of A1-A14, the set of extrapolation filters comprises filters having different shapes. In some embodiments, the set of extrapolation filters comprises filters having different prediction orders and/or shapes.

(A16) In some embodiments of A15, the set of extrapolation filters comprises a filter having a fixed filter shape. For example, a fixed filter shape may be used to predict whole block samples regardless of the current block shape, block size, and/or other coding information.

(A17) In some embodiments of A15, selecting the selected extrapolation filter comprises a selecting a filter shape and identifying the selected extrapolation filter as having the filter shape. In some embodiments, the filter shape is selected based on a block size of the current block (e.g., a height and/or width of the current block) and/or a block shape of the current block (e.g., an aspect ratio of the current block). As an example, a filter shape may be determined according to a block shape, a block size, and/or other coding information.

(A18) In some embodiments of A17, the filter shape is selected according to an output of a classifier classifying one or more reference samples. For example, a filter shape can be determined using a classifier. In some embodiments, the video bitstream includes an indicator indicating which filter shape to use for the current block. For example, a filter shape may be determined according to rate-distortion based cost (e.g., calculated at an encoding component) and the selected filter shape may be signaled using a syntax element.

(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes (i) receiving video data (e.g., a source video sequence) comprising a current picture that includes a plurality of blocks, the plurality of blocks including a current block. The method includes (ii) selecting a selected extrapolation filter from a set of extrapolation filters; (iii) encoding the current block by applying the selected extrapolation filter; and (iv) signaling the encoded current block in a video bitstream.

(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes: (i) obtaining a source video sequence that comprises a plurality of frames; and (ii) performing a conversion between the source video sequence and a video bitstream of visual media data according to a format rule, wherein the video bitstream comprises a current block; and wherein the format rule specifies that: (a) a selected extrapolation filter is to be selected from a set of extrapolation filters; (b) a prediction sample for the current block is to be derived using an extrapolated intra prediction with the selected extrapolation filter; and (c) the current block is to be reconstructed using the derived prediction sample.

(D1) In another aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream comprising a plurality of blocks that includes a current block; (ii) selecting a parameter for an extrapolation filter, where the parameter indicates at least one of a filter shape and a prediction order; (iii) deriving a prediction sample for the current block using the extrapolation filter with the selected parameter; and (iv) reconstructing the current block using the derived prediction sample.

(D2) In some embodiments of D1, the parameter indicates a fixed filter shape that is independent of a block shape of the current block and a block size of the current block.

(D3) In some embodiments of D1 or D2, the method further includes parsing an indicator from the video bitstream, the indicator indicating the parameter for the extrapolation filter, wherein the parameter is selected according to the indicator. For example, a filter shape can be determined according to rate-distortion based cost (e.g., at an encoder component) and signaled in the video bitstream.

(D4) In some embodiments of any of D1-D3, the parameter is selected according to an output of a classifier classifying one or more reference samples.

(E1) In another aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) (i) receiving a video bitstream comprising a plurality of blocks that includes a current block; (ii) generating a partial prediction block for the current block using an extrapolation filter; (iii) reconstructing a portion of the current block corresponding to the partial prediction block by applying a transformation; (iv) deriving a prediction sample for a second portion of the current block based on the reconstructed portion of the current block; and (v) reconstructing the current block using the derived prediction sample. In some embodiments, the prediction sample is derived based on the reconstructed portion and one or more reference samples (e.g., predicted reference samples).

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A18, B1, C1, D1-D4, and E1 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A18, B1, C1, D1-D4, and E1 above).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks that includes a current block;
selecting a selected extrapolation filter from a set of extrapolation filters;
deriving a prediction sample for the current block using an extrapolated intra prediction with the selected extrapolation filter; and
reconstructing the current block using the derived prediction sample.

2. The method of claim 1, wherein the selected extrapolation filter is selected from the set of extrapolation filters according to an output of a classifier classifying one or more reference samples.

3. The method of claim 2, wherein the classifier uses a template-based intra prediction mode derivation to classify the one or more reference samples.

4. The method of claim 2, wherein the classifier is a gradients-based classifier configured to derive at least one of directionality of the one or more reference samples and activity of the one or more reference samples.

5. The method of claim 2, wherein the classifier is a matrix-based classifier.

6. The method of claim 2, wherein the one or more reference samples comprise reconstructed samples.

7. The method of claim 1, wherein a set of filter coefficients for the selected extrapolation filter are trained in an offline manner.

8. The method of claim 1, wherein a set of filter coefficients for the selected extrapolation filter are trained using a set of neighboring samples of the current block.

9. The method of claim 1, wherein the set of extrapolation filters includes at least one fixed filter and at least one adaptive filter.

10. The method of claim 1, further comprising parsing an indicator from the video bitstream, wherein the indicator indicates which filter to use from the set of extrapolation filters and wherein the selected extrapolation filter is selected according to the indicator.

11. The method of claim 1, further comprising selecting the set of extrapolation filters from a group of extrapolation filter sets.

12. The method of claim 11, further comprising parsing an indicator from the video bitstream, wherein the indicator indicates which filter set to use from the group of extrapolation filter sets and wherein the set of extrapolation filters is selected from the group of extrapolation filter sets according to the indicator.

13. The method of claim 11, further comprising parsing an indicator from the video bitstream, wherein the indicator indicates which filter to use from the set of extrapolation filters; and
wherein the set of extrapolation filters are selected from the group of extrapolation filter sets according to an output of a classifier classifying one or more reference samples.

14. The method of claim 1, wherein the prediction sample is derived using one or more different extrapolation filter shapes.

15. The method of claim 1, wherein the set of extrapolation filters comprises filters having different shapes.

16. The method of claim 15, wherein the set of extrapolation filters comprises a filter having a fixed filter shape.

17. The method of claim 15, wherein selecting the selected extrapolation filter comprises a selecting a filter shape and identifying the selected extrapolation filter as having the filter shape.

18. The method of claim 17, wherein the filter shape is selected according to an output of a classifier classifying one or more reference samples.

19. A method of video encoding performed at a computing system having memory and one or more processors, the method comprising:
receiving video data comprising a current picture that includes plurality of blocks, the plurality of blocks including a current block;
selecting a selected extrapolation filter from a set of extrapolation filters;
encoding the current block by applying the selected extrapolation filter; and
signaling the encoded current block in a video bitstream.

20. A non-transitory computer-readable storage medium storing a video bitstream that is generated by a video encoding method, the video encoding method comprising:
receiving video data comprising a current picture that includes plurality of blocks, the plurality of blocks including a current block;
selecting a selected extrapolation filter from a set of extrapolation filters;
encoding the current block by applying the selected extrapolation filter; and
signaling the encoded current block in a video bitstream.
